(19) United States
(12) Patent Application Publication
(10) Pub. No.: US 2014/0305038 A1
(43) Pub. Date: Oct. 16, 2014

(54) STABLE CABLE WIRE

(71) Applicant: Thomas J. DECKER, Glen Allen, CA (US)

(72) Inventor: Thomas J. DECKER, Glen Allen, CA (US)

(21) Appl. No.: 14/172,811

(22) Filed: Feb. 4, 2014

Related U.S. Application Data
(63) Continuation-in-part of application No. 13/182,388, filed on Jul. 13, 2011, now Pat. No. 8,640,382.
(60) Provisional application No. 61/364,085, filed on Jul. 14, 2010.

(51) Int. Cl. A01G 17/12

(52) U.S. Cl. CPC A01G 17/12
USPC 47/42

(57) ABSTRACT

A stable cable wire is disclosed. The stable cable wire comprises a wire and at least one loop formed within the wire. In one embodiment, the wire is a stranded wire that includes a plurality of wires wound up together during a stranding process. Prior to the stranding process, at least one of the plurality of wires is looped with one or more loops during a looping process. After the looping process, the plurality of wires are stranded together and coiled upon a wire spool to create the stable cable wire.

### CROSS-REFERENCE TO RELATED APPLICATIONS

This application is a continuation-in-part of U.S. patent application Ser. No. 13/182,388, filed on Jul. 13, 2011, entitled “STABLE CABLE SYSTEM AND METHOD,” which claims the benefit of U.S. Provisional Patent Application No. 61/364,085, filed on Jul. 14, 2010, entitled “STABLE CABLE,” all of which are incorporated herein by reference in their entireties. This application also claims the benefit to U.S. Provisional Patent Application No. 61/650,319, filed on May 22, 2012, entitled “STABLE CABLE WIRE,” which is also incorporated herein by reference in its entirety.

### FIELD OF THE INVENTION

The present invention relates to wiring systems, and more particularly, to a stable cable wire utilized to stabilize objects.

### BACKGROUND

Stabilizing objects is a problem in numerous settings. In the growing and care of trees, nurseries face problems with maintaining their tree inventories. Storing the trees upright and straight presents a major problem for these nurseries when dealing with large numbers of trees. Conventionally, nurseries string cables from stakes at various distances and then tie the trees to these cables with tape to help maintain their tree inventories. This conventional system does not provide adequate stability against wind and other factors that forces the trees to slide along the cable and lean in the direction of the wind. As a result, irrigation issues can arise and the trees can get damaged. Nursery labor is also frequently utilized to straighten the trees that have been blown over by the wind which increases nursery costs.

Accordingly what is needed is a system and method that overcomes the above-identified issues. The system and method should be cost effective, easily implemented and adaptable to existing environments. The present invention addresses such a need.

### SUMMARY OF THE INVENTION

A stable cable wire is disclosed. The stable cable wire comprises a wire and at least one loop formed within the wire. In one embodiment, the wire is a stranded wire that includes a plurality of wires wound up together during a stranding process. Prior to the stranding process, at least one of the plurality of wires is looped with one or more loops during a looping process. After the looping process, the plurality of wires are stranded together and coiled upon a wire spool to create the stable cable wire.

### BRIEF DESCRIPTION OF THE DRAWINGS

The accompanying drawings illustrate embodiments of the invention and, together with the description, serve to explain the principles of the invention. One of ordinary skill in the art will recognize that the particular embodiments illustrated in the drawings are merely exemplary, and are not intended to limit the scope of the present invention.

FIG. 1 illustrates a conventional tree stabilizing method.

FIG. 2 illustrates a stable cable system in accordance with an embodiment.

FIG. 3 illustrates a close-up view of a stable cable system in accordance with an embodiment.

FIG. 4 illustrates a stable cable wire in accordance with an embodiment.

### DETAILED DESCRIPTION

The present invention relates to wiring systems, and more particularly, to a stable cable wire utilized to stabilize objects. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

A stable cable wire is disclosed. The stable cable wire is made from at least one stranded wire with loops along the at least one stranded wire that are at designated distances between the loops. The loop distance of separation between the loops along the at least one stranded wire can be a variety of distances including but not limited to 2 inches apart to more than 2 feet apart. The loops are continuous along the stranded wire and are formed using one or more stranded wires without cutting or breaking the one or more stranded wires that form the stable cable wire.

Although aspects of the present invention will be described in the context of a tree as the object being stabilized, one of ordinary skill in the art readily recognizes that the descriptions are applicable to stabilizing any type of object or product desired including but not limited to signs, flags, hanging pots and shade cloth and that would be within the spirit and scope of the present invention.

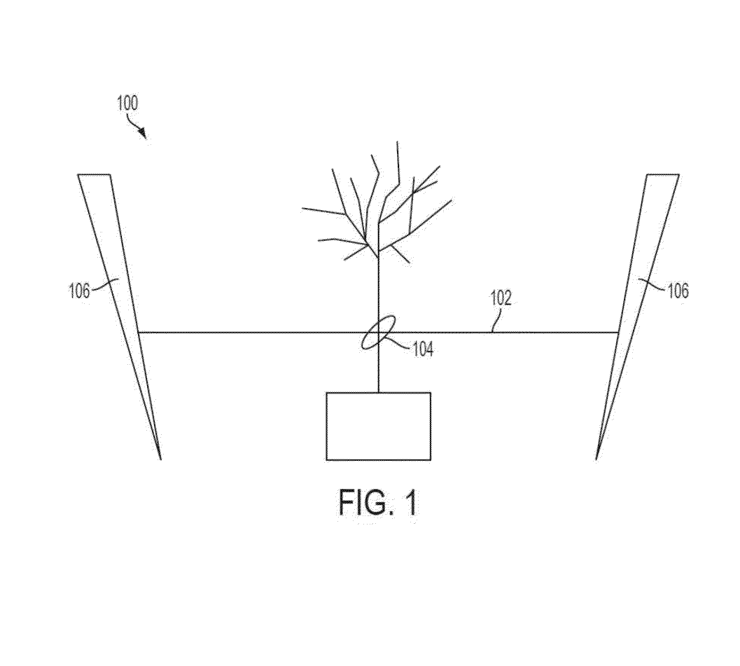

In a conventional tree stabilizing system, nurseries string wires from stakes at various distances and then tie the trees to these wires with tape. FIG. 1 illustrates this conventional tree stabilizing system 100 that includes at least one wire 102, tape 104, and at least two stakes 106. The at least one wire 102 is strung between the at least two stakes 106 and the trees are commonly tied to the at least one wire 102 with tape 104. The tree is typically tied at two to four feet up the tree trunk depending on the trees size. In one embodiment, the tape 104 is green nursery tape. In another embodiment, two wires are used depending on the location of the nursery and the corresponding weather patterns for that location.

The conventional tree stabilizing system 100 does not provide adequate stability against wind that forces the trees to slide along the wire and lean in the direction of the wind. This causes irrigation issues, damage to the trees and increased nursery labor while having to straighten out the trees.

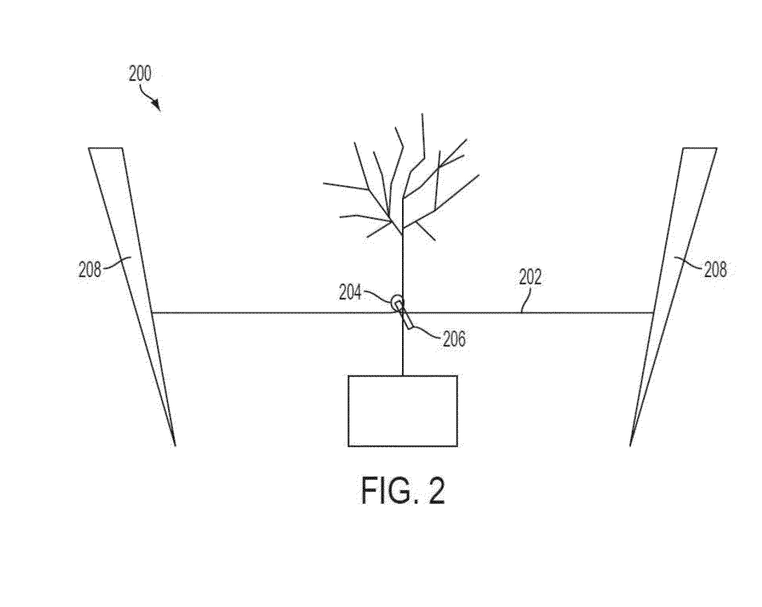

The present invention addresses these drawbacks. FIG. 2 illustrates a stable cable system 200 that includes at least one cable 202, at least one loop 204, at least one connector 206 and at least two stakes 208. In the stable cable system 200, the at least one cable 202 is coupled to the at least two stakes 208. In the stable cable system 200, the at least one cable 202 includes at least one loop 204 and the at least one connector 206 is inserted through the at least one loop 204 and around a tree.

The at least one cable 202 can be of various gauges including but not limited to 8 to 16 gauge and can be a variety of styles and materials including but not limited to a singular wire or a plurality of wires stranded together. In the stable cable system 200, the at least one cable 202 is treated in a variety of ways including but not limited to a galvanizing treatment which deters rust and other deleterious materials from affecting the integrity of the at least one cable 202.

In another embodiment, the at least one cable 202 includes a plurality of pre-formed loops separated by 8 inch interval lengths between each loop. The plurality of pre-formed loops can be used to stabilize a plurality of trees. The plurality of pre-formed loops can be separated by various designated interval lengths along the at least one cable 202 including but not limited to 4, 6, 8, 10 inch, and 2 feet interval lengths.

As a result, the stable cable system 200 provides stability to the tree by holding it in place and not allowing it to move or slide along the at least one cable 202. In so doing, the stable cable system 200 reduces damage to the tree and improves the growth structure of the tree. This increases the yield of the tree and thus increases the nominal value of the tree inventory to the nursery.

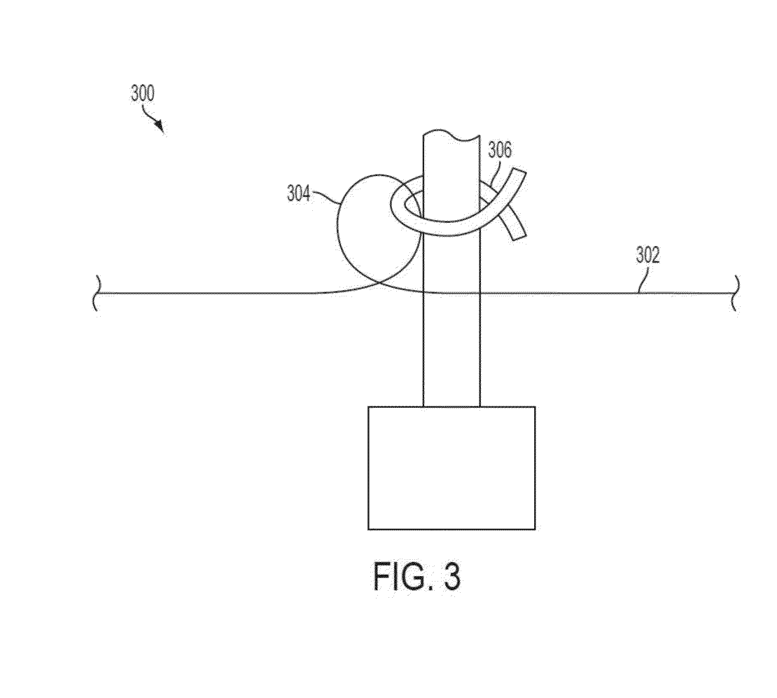

FIG. 3 illustrates a close-up view of the stable cable system 300 including the at least one cable 302, the at least one loop 304 and the at least one connector 306 inserted through the at least one loop 304 and around a tree. In the stable cable system 300, the at least one loop 304 is continuous within the at least one cable 302 and created without breaking or cutting the at least one cable 302 at any point. This greatly enhances the integrity of the stable cable system 300 because it eliminates the possibility of separate parts disengaging from each other over time due to various factors including but not limited to wind and heavy stress.

In another embodiment, the at least one cable 302 is a plurality of wires stranded together which strengthens the integrity of the at least one loop 304. The plurality of wires stranded together become one stabilized unit which enables strong tension to be applied to the at least one cable 302 so that the at least one loop 304 does not unravel. The number of wires in the plurality of wires stranded together can vary in number including but not limited to 2, 3, 4, or 5 wires and the varying number creates different strengths and sizes of the at least one cable 302.

In one embodiment, the stable cable system is used to stabilize irrigation lines used to maintain a tree inventory. Stabilizing irrigation lines also reduces costs associated with irrigation maintenance labor. In another embodiment, the stable cable system is used for trellising row crops including but not limited to olives, kiwis, and grapes thereby replacing the conventional straight cable used to trellis row crops which ensures the proper tying and stability of a vine or espalier of an orchard tree.

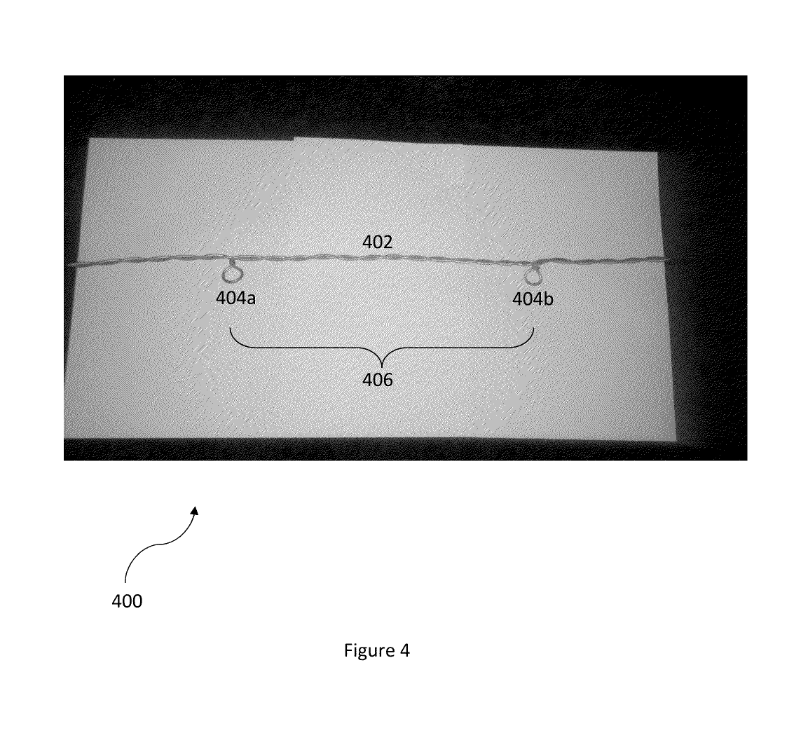

FIG. 4 illustrates a stable cable wire 400 in accordance with an embodiment. The stable cable wire includes a stranded wire 402 and two loops 404a-404b coupled to the stranded wire 402, wherein the two loops 404a-404b are separated by a predetermined interval length 406. In one embodiment, the predetermined interval length 406 is 2 inches. The predetermined interval length 406 can be a variety of distances including but not limited to 2 inches, 1 foot, and 10 feet.

Each of the two loops 404a-404b has a specific diameter and shape. In one embodiment, the diameter of each of the two loops 404a-404b is ¼ inch. The diameter of each of the two loops 404a-404b can be a variety of distances including but not limited to ¼ inch, ½ inch, and 1 inch.

In one embodiment, the stranded wire 402 includes a plurality of wires wound up together during a stranding process. In one embodiment, prior to the stranding process, at least one of the plurality of wires is looped with one or more loops that are each separated by predetermined interval lengths. In another embodiment, each of the plurality of wires is looped with one or more loops at varying locations along each of the plurality of wires. In one embodiment, the one or more loops are each separated by a plurality of varying predetermined interval lengths. After the loops are formed, the plurality of wires are stranded together and coiled upon a wire spool to create the stable cable wire 400.

In one embodiment, the final length of the stable cable wire 400 varies from 1 foot to thousands of feet and the stable cable wire 400 is a continuous wire that is capable of being cut at a variety of different desired lengths. In one embodiment, the types of wires utilized to create the stable cable wire 400 include but are not limited to galvanized iron, copper, and high tensile carbon.

In one embodiment, a stable cable system in accordance with the present invention is utilized for a variety of things including but not limited to tree stabilization, serving as a shade cloth connection wire, soft fruit tree support, vineyard trellising, vegetable trellising, banner and sign hanging, Christmas lighting and other types of lighting support, craft and hobbies, and to bird netting support.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A stable cable wire, comprising:
a wire; and
at least one loop formed within the wire.

2. The stable cable wire of claim 1, wherein the wire includes a plurality of loops, further comprising:
a predetermined interval length between each of the plurality of loops.

3. The stable cable wire of claim 1, wherein the wire includes a first loop, a second loop, and a third loop, further comprising:
a first predetermined interval length between the first loop and the second loop; and
a second predetermined interval length between the second loop and the third loop.

4. The stable cable wire of claim 2, wherein the predetermined interval length is any of 2 inches and 2 feet.

5. The stable cable wire of claim 1, wherein the at least one loop has a diameter that is any of ¼ inch, ½ inch, and 1 inch.

6. The stable cable wire of claim 1, wherein the wire is a stranded wire that includes a plurality of wires wound up together during a stranding process.

7. The stable cable wire of claim 6, wherein prior to the stranding process, at least one of the plurality of wires is looped with one or more loops during a looping process.

8. The stable cable wire of claim 7, wherein the one or more loops are each separated by any of equal predetermined interval lengths and varying predetermined interval lengths.

9. The stable cable wire of claim 7, wherein after the looping process, the plurality of wires are stranded together and coiled upon a wire spool to create the stable cable wire.

10. The stable cable wire of claim 1, wherein the stable cable wire includes a final length of any of 1 foot to 1000 feet.

11. The stable cable wire of claim 1, wherein the stable cable wire is made from any of galvanized iron, copper, and high tensile carbon.
